(19) United States
(12) Patent Application Publication
(10) Pub. No.: US 2021/0310564 A1
(43) Pub. Date: Oct. 7, 2021

(54) VALVE DEVICE

(71) Applicant: NIDEC TOSOK CORPORATION, Kanagawa (JP)

(72) Inventors: Tomohiko NAKANISHI, Kanagawa (JP); Yuji TAKADA, Kanagawa (JP); Hiroki SHIMIZU, Kanagawa (JP); Naoki TAMURA, Kanagawa (JP)

(73) Assignee: NIDEC TOSOK CORPORATION, Kanagawa (JP)

(21) Appl. No.: 17/214,919

(22) Filed: Mar. 28, 2021

(30) Foreign Application Priority Data
Apr. 1, 2020 (JP) 2020-066002

(51) Int. Cl. F16K 1/36; F16K 1/42; F16K 31/06

(52) U.S. Cl. CPC F16K 1/36; F16K 31/0655; F16K 1/42

(57) ABSTRACT

A valve device includes a flow channel member having a first flow channel, and an electromagnetic valve having a movable piece movable in a predetermined direction and being capable of opening and closing the first flow channel. The flow channel member has an annular protrusion surrounding an opening of the first flow channel. A valve body of the movable piece has a valve body base having a large diameter part and a small diameter part connected to the large diameter part with a step therebetween, and an annular elastic body surrounding the small diameter part and attached to the valve body base. The annular elastic body has a first contact surface contacting a surface of a flange of the small diameter part, a second contact surface contacting a step surface of the step, and a seal surface able to contact the annular protrusion.

### CROSS REFERENCE TO RELATED APPLICATIONS

The present invention claims priority under 35 U.S.C. § 119 to Japanese Application No. 2020-066002 filed on Apr. 1, 2020 the entire content of which is incorporated herein by reference.

### BACKGROUND

### Field of the Invention

The disclosure relates to a valve device.

### Background

Valve devices including a flow channel member that has a flow channel and an electromagnetic valve that is capable of opening and closing the flow channel are known.

In the valve device described above, for example, the flow channel is opened and closed by switching between a state in which a valve body of the electromagnetic valve blocks an opening of the flow channel and a state in which the valve body is separated from the opening of the flow channel. However, when the valve body blocks the opening of the flow channel, there is concern that sealing properties of the valve body for the opening may be insufficient and the flow channel may not be able to be sufficiently closed.

### SUMMARY

An exemplary embodiment of the disclosure provides a valve device including a flow channel member that has a first flow channel, and an electromagnetic valve that has a movable piece capable of moving in a predetermined direction and is capable of opening and closing the first flow channel. The first flow channel has an opening which opens to one side in the predetermined direction. The flow channel member has an annular protrusion which surrounds the opening. The movable piece has a valve body which is able to come into contact with the annular protrusion from the one side in the predetermined direction. The valve body has a valve body base which has a large diameter part and a small diameter part having an outer diameter smaller than an outer diameter of the large diameter part and connected to the large diameter part on the other side in the predetermined direction with a step therebetween, and an annular elastic body which has an annular shape surrounding the small diameter part and is attached to the valve body base. The small diameter part has a flange which protrudes outward in a radial direction. The annular elastic body has a first contact surface which comes into contact with a surface of the flange on the one side in the predetermined direction, a second contact surface in an annular shape which comes into contact with a step surface of the step directed to the other side in the predetermined direction, and a seal surface in an annular shape which is able to come into contact with the annular protrusion from the one side in the predetermined direction. At least portions of the seal surface, the second contact surface, the step surface, and the annular protrusion overlap each other when viewed in the predetermined direction.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a cross-sectional view illustrating a valve device according to an exemplary embodiment of the present disclosure and is a view illustrating an open state in which a first flow channel is open.

FIG. 2 is a cross-sectional view illustrating a valve device according to an exemplary embodiment of the present disclosure and is a view illustrating a closed state in which the first flow channel is closed.

FIG. 3 is a cross-sectional view illustrating a part of the valve device according to an exemplary embodiment of the present disclosure.

### DETAILED DESCRIPTION

In the following description, a direction parallel to a Z axis suitably illustrated in each diagram will be referred to as a vertical direction. A positive side of the Z axis will be referred to as an upper side, and a negative side of the Z axis will be referred to as a lower side. A center axis J which is an imaginary axis suitably illustrated in each diagram extends in a Z axis direction, that is, a direction parallel to the vertical direction. In the following description, a direction parallel to an axial direction of the center axis J will be simply referred to as “an axial direction”. In addition, unless otherwise specified, a radial direction centering on the center axis J will be simply referred to as “a radial direction”, and a circumferential direction centering on the center axis J will be simply referred to as “a circumferential direction”.

In this exemplary embodiment, the axial direction corresponds to “a predetermined direction”. The upper side corresponds to “one side in the predetermined direction”, and the lower side corresponds to “the other side in the predetermined direction”. The vertical direction, the upper side, and the lower side are names for simply describing relative positional relationships between parts, and actual disposition relationships and the like may be disposition relationships and the like other than the disposition relationships and the like indicated by these names.

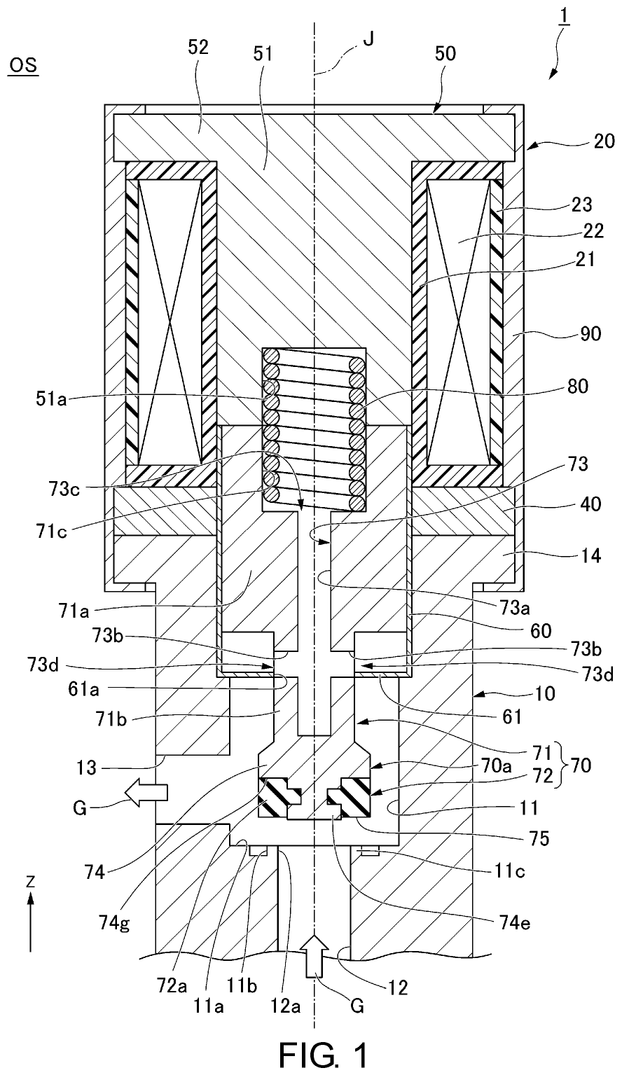

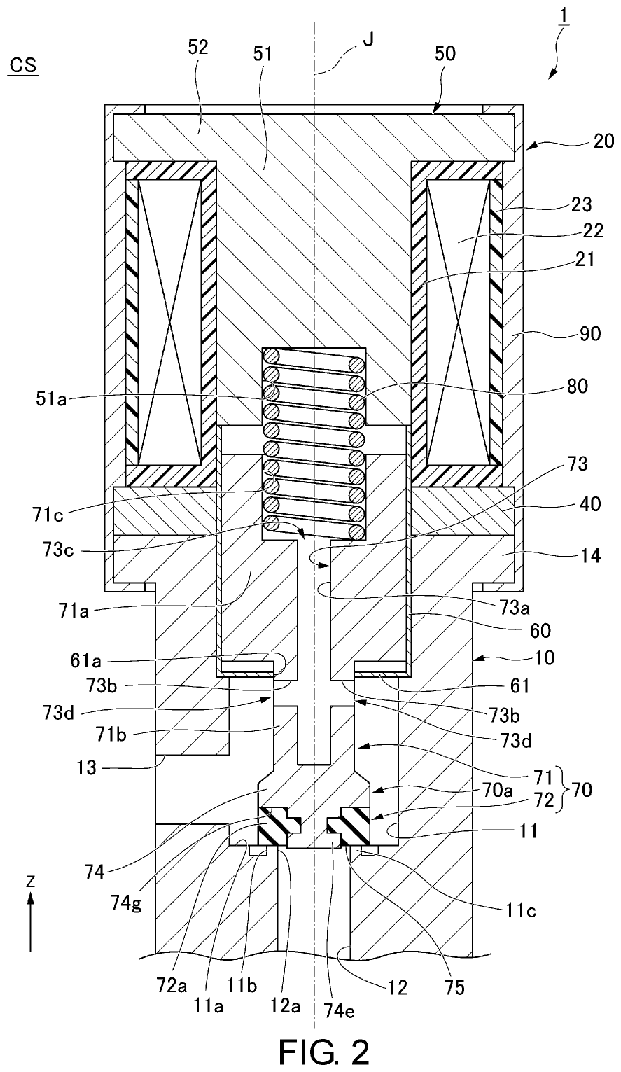

A valve device 1 of this exemplary embodiment illustrated in FIGS. 1 and 2 is mounted in a vehicle. For example, the valve device 1 is a positive crankcase ventilation valve (PCV valve). As illustrated in FIGS. 1 and 2, the valve device 1 of this exemplary embodiment includes a flow channel member 10 and an electromagnetic valve 20. In the exemplary embodiment, the flow channel member 10 is made of metal. For example, a material constituting the flow channel member 10 is aluminum. The flow channel member 10 may be made of resin. When the flow channel member 10 is made of resin, compared with a case in which the flow channel member 10 is made of metal, the weight of the flow channel member 10 is able to be reduced. Accordingly, the weight of the valve device 1 is able to be reduced.

The flow channel member 10 has a valve chamber 11, a first flow channel 12, a second flow channel 13, and a resin flange 14. A valve body 70a (which will be described below) is inserted into the valve chamber 11. In this exemplary embodiment, the valve chamber 11 is defined by blocking an opening of a hole on the upper side recessed from an end of the flow channel member 10 on the upper side to the lower side by the electromagnetic valve 20.

In this exemplary embodiment, the first flow channel 12 is a flow channel through which a fluid flowing into the valve chamber 11 passes. In other words, in this exemplary embodiment, the first flow channel 12 is an inlet port. In this exemplary embodiment, the fluid is a gas G. For example, the gas G is blow-by gas. For example, the first flow channel 12 extends in the axial direction. For example, a flow channel cross-sectional shape of the first flow channel 12 has a substantially circular shape centering on the center axis J. The first flow channel 12 has an opening 12a opening to the upper side.

The opening 12a is one end of the first flow channel 12. The opening 12a opens to the inside of the valve chamber 11. More specifically, the opening 12a opens to a bottom surface 11a on an inner surface of the valve chamber 11 on the lower side. Accordingly, the first flow channel 12 is connected to the valve chamber 11 via the opening 12a. For example, the bottom surface 11a is a substantially flat surface orthogonal to the axial direction.

In this exemplary embodiment, an annular groove 11b recessed to the lower side is provided in the bottom surface 11a. The annular groove 11b has a substantially annular shape surrounding the center axis J. For example, the annular groove 11b has a substantially circular annular shape centering on the center axis J. The annular groove 11b surrounds the opening 12a. The annular groove 11b is provided away from an inner circumferential edge of the opening 12a on a side outward in the radial direction. Since the annular groove 11b is provided, an annular protrusion 11c protruding upward and surrounding the opening 12a is provided on an inward side of the annular groove 11b in the radial direction. Namely, the flow channel member 10 has the annular protrusion 11c surrounding the opening 12a.

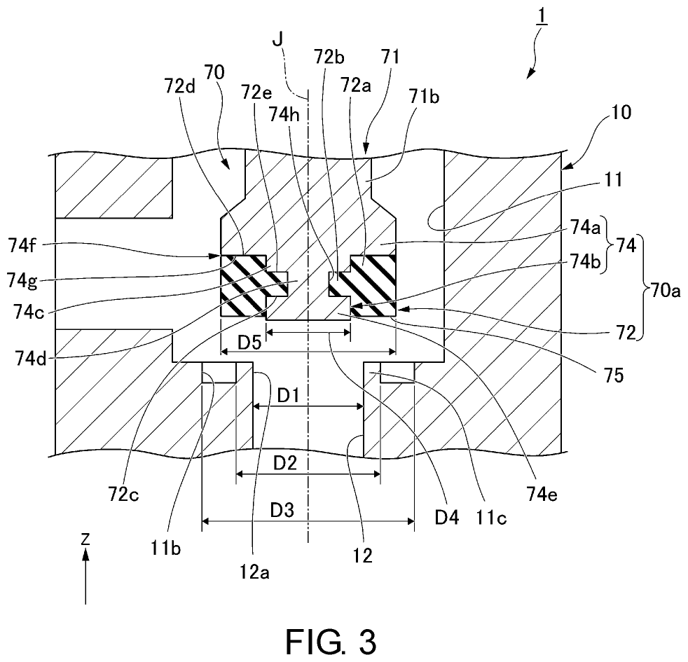

The annular protrusion 11c has a substantially annular shape surrounding the center axis J. For example, the annular protrusion 11c has a substantially circular annular shape centering on the center axis J. In this exemplary embodiment, an inner circumferential surface of the annular protrusion 11c is an inner circumferential surface of the opening 12a. As illustrated in FIG. 3, in this exemplary embodiment, an inner diameter D1 of the annular protrusion 11c is equal to an inner diameter of the opening 12a. An outer diameter D2 of the annular protrusion 11c is equal to an inner diameter of the annular groove 11b. For example, an end surface of the annular protrusion 11c on the upper side is a substantially flat surface orthogonal to the axial direction.

As illustrated in FIGS. 1 and 2, in this exemplary embodiment, the second flow channel 13 is a flow channel through which the gas G that has flowed into the valve chamber 11 via the first flow channel 12 flows out. In other words, in this exemplary embodiment, the second flow channel 13 is an outlet port. For example, the second flow channel 13 extends in a direction orthogonal to the axial direction. For example, the second flow channel 13 extends in a lateral direction in FIGS. 1 and 2. For example, the second flow channel 13 has a substantially circular flow channel cross-sectional shape. The second flow channel 13 is connected to the valve chamber 11. For example, in the second flow channel 13, an end on the right side is connected to the valve chamber 11 in FIGS. 1 and 2.

The resin flange 14 is provided at the end of the flow channel member 10 on the upper side. The resin flange 14 protrudes outward in the radial direction. For example, the resin flange 14 has a substantially circular annular shape centering on the center axis J.

The electromagnetic valve 20 has a bobbin 21, a coil 22, a resin member 23, an annular member 40, a core 50, a guiding tube 60, a movable piece 70, an elastic member 80, and an accommodation case 90. The bobbin 21 has a substantially tubular shape surrounding the center axis J. For example, the bobbin 21 has a substantially cylindrical shape centering on the center axis J and opening to both sides in the axial direction. The coil 22 is wound around the bobbin 21. In this exemplary embodiment, the bobbin 21 is made of resin. The coil 22 is wound around the center axis J extending in the axial direction. In this exemplary embodiment, the coil 22 is wound around an outer circumferential surface of the bobbin 21. The resin member 23 covers the coil 22 from a side outward in the radial direction.

The annular member 40 is made of a magnetic material. The annular member 40 has a substantially annular shape surrounding the center axis J. For example, the annular member 40 has a substantially circular annular shape centering on the center axis J. For example, an inner circumferential surface of the annular member 40 is located at the same position as an inner circumferential surface of the bobbin 21 in the radial direction. For example, an outer circumferential surface of the annular member 40 is located at the same position as an outer circumferential surface of the resin flange 14 in the radial direction. The annular member 40 is located on the lower side of the bobbin 21. The annular member 40 is located on the upper side of the resin flange 14. The annular member 40 is interposed between the bobbin 21 and the resin flange 14 in the axial direction.

The core 50 is made of a magnetic material. The core 50 has a core main body 51 and a core flange 52. The core main body 51 has a substantially pillar shape extending in the axial direction. For example, the core main body 51 has a substantially columnar shape centering on the center axis J. The core main body 51 is inserted into an inward side of the bobbin 21 in the radial direction from the upper side. In this exemplary embodiment, the core main body 51 is fitted into the inward side of the bobbin 21 in the radial direction. The core main body 51 has a holding recess 51a recessed from a surface of the core main body 51 on the lower side to the upper side. For example, the holding recess 51a has a substantially circular shape centering on the center axis J when viewed in the axial direction.

The core flange 52 protrudes outward in the radial direction from an end of the core main body 51 on the upper side. For example, the core flange 52 has a substantially circular annular shape centering on the center axis J. For example, an outer circumferential surface of the core flange 52 is located at the same position as the outer circumferential surface of the resin flange 14 and the outer circumferential surface of the annular member 40 in the radial direction. The core flange 52 comes into contact with an end of the bobbin 21 on the upper side.

The guiding tube 60 has a substantially tubular shape surrounding the movable piece 70. For example, the guiding tube 60 has a substantially cylindrical shape centering on the center axis J and opening to the upper side. The guiding tube 60 supports the movable piece 70 in a manner of being able to move in the axial direction. For example, the guiding tube 60 is made of a non-magnetic material. For example, the guiding tube 60 is made of metal which is a non-magnetic material. The guiding tube 60 has a bottom 61 located on the lower side. The bottom 61 has a substantially plate shape whose plate surface is directed in the axial direction. The bottom 61 has a penetration hole 61a penetrating the bottom 61 in the axial direction. For example, the penetration hole 61a has a substantially circular shape centering on the center axis J.

The movable piece 70 is able to move in the axial direction. The movable piece 70 has a movable piece main body 71 and an annular elastic body 72. The movable piece main body 71 is made of a magnetic material. The movable piece main body 71 extends in the axial direction. For example, the movable piece main body 71 has a substantially columnar shape centering on the center axis J. The movable piece main body 71 has a body 71a, a neck 71b, and a valve body base 74. In this exemplary embodiment, the valve body 70a includes the valve body base 74 and the annular elastic body 72. Namely, the movable piece 70 has the valve body 70a, and the valve body 70a has the valve body base 74 and the annular elastic body 72. The valve body 70a is able to come into contact with the annular protrusion 11c from the upper side.

In this exemplary embodiment, the body 71a is an upper portion of the movable piece main body 71. The body 71a is fitted into the inward side of the guiding tube 60 in the radial direction. The body 71a is supported by the guiding tube 60 in a manner of being able to move in the axial direction. A dimension of the body 71a in the axial direction is smaller than a dimension of the guiding tube 60 in the axial direction. An outer edge of the body 71a in the radial direction is provided in a manner of facing the upper side of the bottom 61 with a gap therebetween.

The body 71a has a holding recess 71c recessed from an end surface of the body 71a on the upper side to the lower side. For example, the holding recess 71c has a substantially circular shape centering on the center axis J when viewed in the axial direction. The holding recess 71c faces the holding recess 51a provided in the core 50 in the axial direction. Insides of the holding recesses 51a and 71c are portions inside the electromagnetic valve 20 where the elastic member 80 is provided. The end surface of the body 71a on the upper side is an end surface of the movable piece main body 71 on the upper side. The end surface of the movable piece main body 71 on the upper side faces an end surface of the core 50 on the lower side in the axial direction. In this exemplary embodiment, the end surface of the core 50 on the lower side is an end surface of the core main body 51 on the lower side.

In this exemplary embodiment, the neck 71b is a part of a lower portion of the movable piece main body 71. The neck 71b extends from an end of the body 71a on the lower side to the lower side. An outer diameter of the neck 71b is smaller than an outer diameter of the body 71a. The neck 71b passes through the penetration hole 61a in the axial direction. The neck 71b is fitted into the inside of the penetration hole 61a. A lower portion of the neck 71b is inserted into the valve chamber 11 via the penetration hole 61a.

The valve body base 74 is connected to an end of the neck 71b on the lower side. For example, the valve body base 74 has a substantially columnar shape centering on the center axis J. As illustrated in FIG. 3, the valve body base 74 has a large diameter part 74a and a small diameter part 74b. The large diameter part 74a is a portion connected to the end of the neck 71b on the lower side. For example, an outer diameter of the large diameter part 74a is larger than the outer diameter of the neck 71b, an inner diameter of the penetration hole 61a, the inner diameter D1 of the annular protrusion 11c, and the outer diameter D2 of the annular protrusion 11c. For example, the outer diameter of the large diameter part 74a is smaller than an outer diameter D3 of the annular groove 11b.

An outer diameter of the small diameter part 74b is smaller than the outer diameter of the large diameter part 74a. The small diameter part 74b is connected to the lower side of the large diameter part 74a with a step 74f therebetween. The step 74f is a step recessed inward in the radial direction when an outer circumferential surface of the valve body base 74 is followed from the large diameter part 74a to the small diameter part 74b. The step 74f has a step surface 74g facing the lower side. The step surface 74g is a surface of the large diameter part 74a on the lower side. For example, the step surface 74g is a substantially flat surface orthogonal to the axial direction. For example, the step surface 74g has a substantially circular annular shape centering on the center axis J. For example, an inner diameter of the step surface 74g is smaller than the inner diameter D1 of the annular protrusion 11c. An outer diameter of the step surface 74g is equal to the outer diameter of the large diameter part 74a.

The small diameter part 74b has a groove 74h recessed inward in the radial direction at a center part in the axial direction. The groove 74h has a substantially annular shape surrounding the center axis J. For example, the groove 74h has a substantially circular annular shape centering on the center axis J. Since the groove 74h is provided, the small diameter part 74b has three portions whose outer diameters vary in the axial direction. Namely, the small diameter part 74b has a root 74c, a joint 74d, and a flange 74e.

The root 74c is a portion of the small diameter part 74b located above the groove 74h. The root 74c is connected to the large diameter part 74a. More specifically, the root 74c is connected to the lower side of the large diameter part 74a with the step 74f therebetween.

The joint 74d is a portion of the small diameter part 74b where the groove 74h is provided. An outer diameter of the joint 74d is smaller than an outer diameter of the root 74c and an outer diameter of the flange 74e. The joint 74d is connected to the lower side of the root 74c with a step therebetween. The joint 74d connects the root 74c and the flange 74e to each other in the axial direction.

The flange 74e is a portion of the small diameter part 74b located below the groove 74h. In this exemplary embodiment, the flange 74e is an end of the small diameter part 74b on the lower side. The outer diameter of the flange 74e is larger than the outer diameter of the joint 74d. For example, the outer diameter of the flange 74e is equal to the outer diameter of the root 74c. The flange 74e is connected to the lower side of the joint 74d with a step therebetween. The flange 74e protrudes further outward in the radial direction than the joint 74d. An outer portion of the flange 74e in the radial direction is provided below an outer portion of the root 74c on the lower side in the radial direction with a space therebetween.

The annular elastic body 72 has a substantially annular shape surrounding the small diameter part 74b. For example, the annular elastic body 72 has a substantially circular annular shape centering on the center axis J. The annular elastic body 72 is attached to the valve body base 74. In this exemplary embodiment, the annular elastic body 72 is fitted to the small diameter part 74b and is attached to the valve body base 74. For example, the annular elastic body 72 is made of rubber. The annular elastic body 72 has a main body 72a and a sandwiched part 72b.

The main body 72a surrounds a portion of the small diameter part 74b excluding a lower end of the flange 74e. For example, the main body 72a has a substantially circular annular shape centering on the center axis J. An inner circumferential surface of the main body 72a comes into contact with an outer circumferential surface of the root 74c and an outer circumferential surface of the flange 74e. The main body 72a is located on the lower side of the step surface 74g. A surface of the main body 72a on the upper side is a second contact surface 72d which comes into contact with the step surface 74g. Namely, the annular elastic body 72 has the second contact surface 72d which comes into contact with the step surface 74g facing the lower side in the step 74f. Accordingly, upward movement of the annular elastic body 72 with respect to the valve body base 74 is able to be curbed.

The second contact surface 72d is a substantially annular surface facing the upper side. For example, the second contact surface 72d is a substantially flat surface orthogonal to the axial direction. For example, the second contact surface 72d has a substantially circular annular shape centering on the center axis J. For example, an inner diameter of the second contact surface 72d is equal to the inner diameter of the step surface 74g. For example, an outer diameter of the second contact surface 72d is equal to the outer diameter of the step surface 74g. For example, an inner edge of the second contact surface 72d in the radial direction is located at the same position in the radial direction as an inner edge of the step surface 74g in the radial direction. For example, an outer edge of the second contact surface 72d in the radial direction is located at the same position in the radial direction as an outer edge of the step surface 74g in the radial direction. In this exemplary embodiment, the entire second contact surface 72d comes into contact with the step surface 74g. For example, the entire second contact surface 72d and the entire step surface 74g overlap each other when viewed in the axial direction.

A surface of the main body 72a on the lower side is a seal surface 75 which is able to come into contact with the annular protrusion 11c from the upper side. Namely, the annular elastic body 72 has the seal surface 75. The seal surface 75 is a substantially annular surface facing the lower side. For example, the seal surface 75 is a substantially flat surface orthogonal to the axial direction. For example, the seal surface 75 has a substantially circular annular shape centering on the center axis J. In this exemplary embodiment, the seal surface 75 is located on a side outward in the radial direction from the flange 74e. The seal surface 75 surrounds the flange 74e. For example, the seal surface 75 is located above an end surface of the flange 74e on the lower side. In this exemplary embodiment, the end surface of the flange 74e on the lower side is an end surface of the small diameter part 74b on the lower side.

In this exemplary embodiment, an inner diameter D4 of the seal surface 75 is smaller than the inner diameter D1 of the annular protrusion 11c. Accordingly, an inner edge of the seal surface 75 is located on a side inward from an inner edge of the annular protrusion 11c when viewed in the axial direction. In other words, the inner edge of the seal surface 75 in the radial direction is located on a side inward in the radial direction from the inner edge of the annular protrusion 11c in the radial direction. For example, the inner diameter D4 of the seal surface 75 is equal to the outer diameter of the flange 74e. For example, an inner diameter D4 of the seal surface 75 is equal to the inner diameter of the second contact surface 72d and the inner diameter of the step surface 74g. For example, the inner edge of the seal surface 75 in the radial direction is located at the same position in the radial direction as the inner edge of the second contact surface 72d in the radial direction and the inner edge of the step surface 74g in the radial direction.

An outer diameter D5 of the seal surface 75 is larger than the outer diameter D2 of the annular protrusion 11c. Accordingly, an outer edge of the seal surface 75 is located on a side outward from an outer edge of the annular protrusion 11c when viewed in the axial direction. In other words, the outer edge of the seal surface 75 in the radial direction is located on a side outward in the radial direction from the outer edge of the annular protrusion 11c in the radial direction. For example, the outer diameter D5 of the seal surface 75 is smaller than the outer diameter D3 of the annular groove 11b. For example, the outer diameter of the seal surface 75 is equal to the outer diameter of the second contact surface 72d and the outer diameter of the step surface 74g. For example, the outer edge of the seal surface 75 in the radial direction is located at the same position in the radial direction as the outer edge of the second contact surface 72d in the radial direction and the outer edge of the step surface 74g in the radial direction.

In this exemplary embodiment, the entire seal surface 75 overlaps the second contact surface 72d and the step surface 74g when viewed in the axial direction. For example, the entire seal surface 75, the entire second contact surface 72d, and the entire step surface 74g overlap each other when viewed in the axial direction. At least portions of the seal surface 75, the second contact surface 72d, the step surface 74g, and the annular protrusion 11c overlap each other when viewed in the axial direction. The entire annular protrusion 11c overlaps the seal surface 75, the second contact surface 72d, and the step surface 74g when viewed in the axial direction. For example, a surface area of the seal surface 75, a surface area of the second contact surface 72d, and a surface area of the step surface 74g are equal to each other. A surface area of a surface of the annular protrusion 11c on the upper side is smaller than the surface area of the seal surface 75, the surface area of the second contact surface 72d, and the surface area of the step surface 74g.

The sandwiched part 72b protrudes inward in the radial direction from the inner circumferential surface of the main body 72a. The sandwiched part 72b has a substantially annular shape surrounding the joint 74d. For example, the sandwiched part 72b has a substantially circular annular shape centering on the center axis J. An inner circumferential surface of the sandwiched part 72b comes into contact with an outer circumferential surface of the joint 74d. The sandwiched part 72b is fitted into the inside of the groove 74h. The sandwiched part 72b is sandwiched between the root 74c and the flange 74e in the axial direction.

The sandwiched part 72b has a first contact surface 72c and a third contact surface 72e. Namely, the annular elastic body 72 has the first contact surface 72c and the third contact surface 72e. The first contact surface 72c is a surface of the sandwiched part 72b on the lower side. The first contact surface 72c faces the lower side. For example, the first contact surface 72c is a substantially flat surface orthogonal to the axial direction. For example, the first contact surface 72c has a substantially circular annular shape centering on the center axis J. The first contact surface 72c comes into contact with a surface of the flange 74e on the upper side. Accordingly, downward movement of the annular elastic body 72 with respect to the valve body base 74 is able to be curbed. In this manner, since the first contact surface 72c comes into contact with the surface of the flange 74e on the upper side and the second contact surface 72d comes into contact with the step surface 74g, movement of the annular elastic body 72 in the axial direction with respect to the valve body base 74 is able to be curbed. Therefore, detachment of the annular elastic body 72 from the valve body base 74 in the axial direction is able to be curbed.

The third contact surface 72e is a surface of the sandwiched part 72b on the upper side. The third contact surface 72e faces the upper side. For example, the third contact surface 72e is a substantially flat surface orthogonal to the axial direction. For example, the third contact surface 72e has a substantially circular annular shape centering on the center axis J. For example, the third contact surface 72e comes into contact with a surface of the root 74c on the lower side.

As illustrated in FIGS. 1 and 2, the movable piece main body 71 has a vent hole 73. Accordingly, the movable piece 70 has the vent hole 73. The vent hole 73 has an axial extension 73a and radial extensions 73b. The axial extension 73a extends in the axial direction from a bottom surface of the holding recess 71c to the neck 71b. The bottom surface of the holding recess 71c is a surface of an inner surface of the holding recess 71c located on the lower side. In a cross-section orthogonal to the axial direction in which the axial extension 73a extends, for example, the axial extension 73a has a substantially circular cross-sectional shape centering on the center axis J. The axial extension 73a is a hole having a bottom on the lower side.

An end of the axial extension 73a on the upper side is an inner opening 73c. Accordingly, the vent hole 73 has the inner opening 73c. The inner opening 73c opens to the upper side and opens to the inside of the holding recess 71c. In other words, the inner opening 73c opens to a portion inside the electromagnetic valve 20 where the elastic member 80 is provided. The vent hole 73 is connected to the inside of the electromagnetic valve 20 via the inner opening 73c.

In this exemplary embodiment, the radial extensions 73b are provided in the neck 71b. More specifically, the radial extensions 73b are provided in an upper portion of the neck 71b. The radial extensions 73b extend in the radial direction from an inner circumferential surface of the axial extension 73a to an outer circumferential surface of the neck 71b. In a cross section orthogonal to the radial direction in which the radial extensions 73b extend, for example, the radial extensions 73b have a substantially circular cross-sectional shape. For example, a pair of radial extensions 73b are provided with the center axis J interposed therebetween.

An end of the radial extension 73b on a side outward in the radial direction is an outer opening 73d. Accordingly, the vent hole 73 has the outer openings 73d. The outer opening 73d opens to a side outward in the radial direction. As illustrated in FIG. 2, the outer opening 73d opens to the inside of the valve chamber 11 in a state in which the seal surface 75 comes into contact with the annular protrusion 11c. A state in which the seal surface 75 comes into contact with the annular protrusion 11c is a closed state CS, which will be described below. In this exemplary embodiment, in the closed state CS, the entire outer opening 73d opens to the inside of the valve chamber 11. Meanwhile, as illustrated in FIG. 1, the entire outer opening 73d is accommodated inside the guiding tube 60 in a state in which the seal surface 75 is farthest from the annular protrusion 11c in the axial direction. A state in which the seal surface 75 is farthest from the annular protrusion 11c in the axial direction is a state in which the movable piece 70 provided in a manner of being able to move in the axial direction is located on the uppermost side and is an open state OS, which will be described below.

For example, the elastic member 80 is a coil spring extending in the axial direction. The elastic member 80 is provided inside the electromagnetic valve 20. In this exemplary embodiment, the elastic member 80 is provided in a manner of straddling the inside of the holding recess 51a and the inside of the holding recess 71c. An end of the elastic member 80 on the lower side comes into contact with the bottom surface of the holding recess 71c. An end of the elastic member 80 on the upper side comes into contact with a bottom surface of the holding recess 51a. The bottom surface of the holding recess 51a is a surface of an inner surface of the holding recess 51a located on the upper side. The elastic member 80 applies an elastic force to the movable piece 70 in the axial direction. In this exemplary embodiment, the elastic member 80 applies an elastic force directed for the lower side to the movable piece 70.

The accommodation case 90 has a substantially tubular shape surrounding the center axis J. For example, the accommodation case 90 has a substantially cylindrical shape centering on the center axis J and opening to both sides in the axial direction. The accommodation case 90 internally accommodates the bobbin 21, the coil 22, the resin member 23, the annular member 40, the core 50, an upper portion of the guiding tube 60, an upper portion of the movable piece 70, and the elastic member 80. The accommodation case 90 is made of a magnetic material.

An end of the accommodation case 90 on the lower side is caulked on the inward side in the radial direction and comes into contact with the resin flange 14 from the lower side. An end of the accommodation case 90 on the upper side is caulked on the inward side in the radial direction and comes into contact with the core flange 52 from the upper side. The resin flange 14, the annular member 40, the bobbin 21, and the core flange 52 are sandwiched in the axial direction and are fixed to each other by the caulked portions of the accommodation case 90 on both sides in the axial direction. Accordingly, the electromagnetic valve 20 is attached to the flow channel member 10.

The valve device 1 of this exemplary embodiment switches between the open state OS in which the first flow channel 12 is open and the closed state CS in which the first flow channel 12 is closed by the electromagnetic valve 20. FIG. 1 illustrates the open state OS, and FIG. 2 illustrates the closed state CS.

When no electricity is supplied to the electromagnetic valve 20, the valve device 1 is in the closed state CS illustrated in FIG. 2. In the closed state CS, the movable piece 70 is pushed downward by the elastic member 80, and the seal surface 75 is pressed to the annular protrusion 11c from the upper side. Accordingly, a space between the seal surface 75 and the surface of the annular protrusion 11c on the upper side is sealed throughout the whole circumference, and the opening 12a surrounded by the annular protrusion 11c is blocked by the valve body 70a. Therefore, the first flow channel 12 is closed, and thus inflow of the gas G from the first flow channel 12 to the inside of the valve chamber 11 is inhibited. In the closed state CS in which no electricity is supplied to the electromagnetic valve 20, an upper end surface of the movable piece 70 is located on the lower side away from a lower end surface of the core 50. In this exemplary embodiment, the upper end surface of the movable piece 70 is an upper end surface of the movable piece main body 71. In addition, in the closed state CS, the lower end of the flange 74e is accommodated inside the first flow channel 12.

Meanwhile, when electricity is supplied to the electromagnetic valve 20, the valve device 1 is in the open state OS illustrated in FIG. 1. If electricity is supplied to the electromagnetic valve 20, a current flows to the coil 22, and a magnetic field in which a magnetic flux flows in the axial direction is generated on the inward side of the coil 22 in the radial direction. Accordingly, a magnetic circuit passing through each of the parts made of a magnetic material in the electromagnetic valve 20 is provided.

Specifically, for example, when a magnetic flux caused by a magnetic field of the coil 22 flows from the lower side to the upper side on the inward side of the coil 22 in the radial direction, a magnetic circuit in which a magnetic flux passes through the core main body 51, the core flange 52, the accommodation case 90, and the annular member 40 in this order from the body 71a of the movable piece main body 71 and returns to the body 71a of the movable piece main body 71 is provided. Accordingly, each of the parts made of a magnetic material is excited, and a magnetic force attracting the movable piece main body 71 and the core 50 to each other is generated therebetween. Therefore, a magnetic force generated between the movable piece main body 71 and the core 50 is made greater than the elastic force of the elastic member 80 by supplying sufficient electricity to the electromagnetic valve 20, and thus the movable piece 70 is able to be moved upward against the elastic force of the elastic member 80. Accordingly, the seal surface 75 is separated from the annular protrusion 11c to the upper side, and the opening 12a opens to the inside of the valve chamber 11. Therefore, the first flow channel 12 is opened, and thus inflow of the gas G from the first flow channel 12 to the inside of the valve chamber 11 is allowed. The gas G that has flowed into the valve chamber 11 flows out from the second flow channel 13.

In the open state OS in which electricity is supplied to the electromagnetic valve 20, the upper end surface of the movable piece 70 comes into contact with the lower end surface of the core 50. In this state, the upper end surface of the movable piece main body 71 and the lower end surface of the core 50 are in a stuck state due to a magnetic force.

If supply of electricity to the electromagnetic valve 20 is stopped, a magnetic circuit vanishes, and a magnetic force between the movable piece main body 71 and the core 50 vanishes. Therefore, the movable piece 70 moves downward due to the elastic force of the elastic member 80. Accordingly, the seal surface 75 comes into contact with the annular protrusion 11c, and the first flow channel 12 is closed.

As described above, in this exemplary embodiment, the movable piece 70 is able to be moved in the axial direction by switching ON/OFF of electricity supplied to the electromagnetic valve 20, and the first flow channel 12 is able to be opened and closed in accordance with movement of the movable piece 70. In this manner, the electromagnetic valve 20 is able to open and close the first flow channel 12.

A magnetic field generated by the coil 22 may be a magnetic field in which a magnetic flux flows from the upper side to the lower side on the inward side of the coil 22 in the radial direction. In this case, a magnetic circuit in which a magnetic flux passes through the body 71a of the movable piece main body 71, the annular member 40, the accommodation case 90, and the core flange 52 in this order from the core main body 51 and returns to the core main body 51 is provided. Even in such a magnetic circuit, the movable piece 70 is able to be moved upward due to a magnetic force by exciting each of the parts made of a magnetic material.

According to this exemplary embodiment, the flow channel member 10 has the annular protrusion 11c surrounding the opening 12a. The seal surface 75 of the valve body 70a is able to come into contact with the annular protrusion 11c from the upper side. Therefore, when the valve body 70a is pressed to a circumferential edge of the opening 12a from the upper side due to the movable piece 70 which has moved downward, the seal surface 75 of the valve body 70a comes into contact with the annular protrusion 11c. Accordingly, for example, compared with a case in which the seal surface 75 of the valve body 70a comes into contact with the bottom surface 11a, a contact surface area between the valve body 70a and the circumferential edge of the opening 12a is able to be reduced. Therefore, a pressure generated between the valve body 70a and the circumferential edge of the opening 12a is able to be increased. Therefore, the valve body 70a is able to be suitably pressed to the circumferential edge of the opening 12a. Accordingly, a part between the seal surface 75 and the surface of the annular protrusion 11c on the upper side is able to be suitably sealed. Therefore, the opening 12a surrounded by the annular protrusion 11c is able to be suitably sealed. Therefore, sealing properties of the valve body 70a for the opening 12a are able to be improved. Accordingly, in the closed state CS, leakage of the gas G inside the first flow channel 12 to the inside of the valve chamber 11 is able to be curbed.

In addition, since the annular elastic body 72 is pressed to the annular protrusion 11c by a relatively significant pressure, it is likely to be elastically deformed. Accordingly, the seal surface 75 provided in the annular elastic body 72 is easily brought into tight contact with the annular protrusion 11c. Therefore, a part between the seal surface 75 and the surface of the annular protrusion 11c on the upper side is able to be more suitably sealed. Therefore, sealing properties of the valve body 70a for the opening 12a are able to be further improved.

In addition, according to this exemplary embodiment, at least portions of the seal surface 75, the second contact surface 72d, the step surface 74g, and the annular protrusion 11overlap each other when viewed in the axial direction. Therefore, when the valve body 70a is pressed to the annular protrusion 11c from the upper side due to the movable piece 70 which has moved downward, a downward force applied from the valve body base 74 to the annular elastic body 72 via the step surface 74g and the second contact surface 72d is directly transferred to the surface of the annular protrusion 11c on the upper side in the axial direction via the seal surface 75. Accordingly, the seal surface 75 is able to be suitably pressed to the surface of the annular protrusion 11c on the upper side. Therefore, a part between the seal surface 75 and the surface of the annular protrusion 11c on the upper side is able to be more suitably sealed. Accordingly, sealing properties of the valve body 70a for the opening 12a are able to be further improved.

In addition, if the seal surface 75 is pressed to the annular protrusion 11c from the upper side, an upward reaction force received by the annular elastic body 72 from the annular protrusion 11c is directly transferred to the step surface 74g in the axial direction via the second contact surface 72d. Accordingly, the annular elastic body 72 is suitably pressed to the step surface 74g via the second contact surface 72d. Therefore, a space between the second contact surface 72d and the step surface 74g is also able to be suitably sealed. Therefore, suppose that in the closed state CS, the gas G inside the first flow channel 12 enters a space between the flange 74e and the annular elastic body 72 in the radial direction; even in this case, the entered gas G is able to be blocked in a space between the second contact surface 72d and the step surface 74g. Accordingly, in the closed state CS, leakage of the gas G inside the first flow channel 12 to the inside of the valve chamber 11 is able to be better curbed. Therefore, sealing properties of the valve body 70a for the opening 12a are able to be further improved.

In addition, according to this exemplary embodiment, the inner edge of the seal surface 75 is located on a side inward from the inner edge of the annular protrusion 11c when viewed in the axial direction. The outer edge of the seal surface 75 is located on a side outward from the outer edge of the annular protrusion 11c when viewed in the axial direction. Therefore, when the seal surface 75 is pressed from the upper side to the annular protrusion 11c, a portion of the seal surface 75 coming into contact with the annular protrusion 11c is elastically deformed, and thus the annular protrusion 11c is able to be easily bitten into the annular elastic body 72. Accordingly, the seal surface 75 and the surface of the annular protrusion 11c on the upper side is able to be more suitably brought into tight contact with each other. Therefore, the opening 12a is able to be more suitably sealed. Therefore, sealing properties of the valve body 70a for the opening 12a are able to be further improved. Accordingly, in the closed state CS, leakage of the gas G inside the first flow channel 12 to the inside of the valve chamber 11 is able to be better curbed.

In addition, according to this exemplary embodiment, the entire seal surface 75 overlaps the second contact surface 72d and the step surface 74g when viewed in the axial direction. Therefore, even when any portion of the seal surface 75 comes into contact with the annular protrusion 11c, the seal surface 75 is able to be suitably pressed to the annular protrusion 11c via the step surface 74g and the second contact surface 72d. In addition, the second contact surface 72d is able to be suitably pressed to the step surface 74g due to a reaction force received from the annular protrusion 11c via the seal surface 75. Accordingly, suppose that a contact position on the seal surface 75 with respect to the annular protrusion 11c is misaligned; even in this case, the opening 12a is able to be suitably sealed by the valve body 70a.

In addition, according to this exemplary embodiment, the annular elastic body 72 has the annular sandwiched part 72b which surrounds the joint 74d and is sandwiched between the root 74c and the flange 74e in the axial direction. The sandwiched part 72b has the first contact surface 72c and the third contact surface 72e which comes into contact with the surface of the root 74c on the lower side. Therefore, movement of the sandwiched part 72b in the axial direction with respect to the valve body base 74 is able to be curbed. Accordingly, movement of the annular elastic body 72 in the axial direction with respect to the valve body base 74 is able to be better curbed. Therefore, the annular elastic body 72 is able to be more stably attached to the valve body base 74. In addition, a space between the first contact surface 72c and the surface of the flange 74e on the upper side and a space between the third contact surface 72e and the surface of the root 74c on the lower side is able to be sealed. Therefore, suppose that in the closed state CS, the gas G inside the first flow channel 12 enters a space between the flange 74e and the annular elastic body 72 in the radial direction; even in this case, leakage of the entered gas G to the inside of the valve chamber 11 is able to be better curbed. Therefore, sealing properties of the valve body 70a for the opening 12a are able to be further improved.

In addition, according to this exemplary embodiment, the movable piece 70 has the vent hole 73 connected to the inside of the electromagnetic valve 20. Therefore, the weight of the movable piece 70 is able to be reduced by the amount of the vent hole 73 provided therein.

In addition, according to this exemplary embodiment, the vent hole 73 has the outer opening 73d opening to the inside of the valve chamber 11 in a state in which the seal surface 75 comes into contact with the annular protrusion 11c. Therefore, when the movable piece 70 moves in the axial direction, the inside of the electromagnetic valve 20 and the inside of the valve chamber 11 are connected to each other via the vent hole 73. Accordingly, when the movable piece 70 moves in the axial direction, air is able to flow between the inside of the electromagnetic valve 20 and the inside of the valve chamber 11. Therefore, the movable piece 70 is able to be easily moved in the axial direction.

Specifically, for example, when the movable piece 70 moves downward and the valve device 1 is switched from the open state OS to the closed state CS, air inside the valve chamber 11 is suctioned to a space between the movable piece 70 and the core 50 via the vent hole 73. Accordingly, a situation in which an internal pressure of the electromagnetic valve 20 becomes negative is able to be curbed, and the movable piece 70 is able to be easily moved to the lower side. In addition, for example, when the movable piece 70 moves upward and the valve device 1 is switched from the closed state CS to the open state OS, air between the movable piece 70 and the core 50 is discharged to the inside of the valve chamber 11 via the vent hole 73. Accordingly, the movable piece 70 is able to be easily moved upward.

In addition, according to this exemplary embodiment, the entire outer opening 73d is accommodated inside the guiding tube 60 in a state in which the seal surface 75 is farthest from the annular protrusion 11c in the axial direction. Therefore, the outer opening 73d is able to be accommodated inside the guiding tube 60 in the open state OS. Accordingly, in the open state OS, inflow of the gas G, which has flowed into the valve chamber 11 from the opening 12a, from the outer opening 73d to the vent hole 73 is able to be curbed. Therefore, infiltration of the gas G into the electromagnetic valve 20 via the vent hole 73 is able to be curbed. Therefore, leakage of the gas G to outside of the valve device 1 via the inside of the electromagnetic valve 20 is able to be curbed.

In addition, according to this exemplary embodiment, the elastic member 80 applying an elastic force to the movable piece 70 in the axial direction is provided inside the electromagnetic valve 20. The vent hole 73 has the inner opening 73c opening to a portion inside the electromagnetic valve 20 where the elastic member 80 is provided. Here, as described above, since the outer opening 73d is accommodated inside the guiding tube 60 in the open state OS, inflow of the gas G to the vent hole 73 is curbed. Accordingly, in the open state OS, inflow of the gas G from the inner opening 73c to a portion accommodating the elastic member 80 is also curbed. Therefore, for example, deterioration of the elastic member 80, such as corrosion of the elastic member 80 due to the gas G, is able to be curbed.

The disclosure is not limited to the embodiment described above, and other constitutions and other methods are also able to be employed within the scope of the technical idea of the disclosure. A material constituting a flow channel member is not particularly limited. A material constituting a flow channel member may be metal. The flow channel member may have any shape as long as it has a first flow channel. A fluid flowing in the first flow channel and the second flow channel is not particularly limited, and it may be gas other than blow-by gas or may be liquid. The first flow channel which is opened and closed by an electromagnetic valve may be an outlet port through which a fluid flows out. The flow channel member may not have a valve chamber. The flow channel member may not have a second flow channel.

An annular protrusion may be provided away from an inner edge of an opening on a side outward in the radial direction. In the embodiment described above, the annular groove 11b is not provided on the bottom surface 11a, and the annular protrusion 11c may protrude from the bottom surface 11a to the upper side.

An electromagnetic valve may have any structure as long as it has a movable piece capable of moving in the predetermined direction. In the embodiment described above, the electromagnetic valve has a structure in which the first flow channel is open when electricity is supplied and the first flow channel is closed when no electricity is supplied, but the structure is not limited thereto. The electromagnetic valve may have a structure in which the first flow channel is closed when electricity is supplied and the first flow channel is opened when no electricity is supplied. In addition, the electromagnetic valve may be a self-holding-type electromagnetic valve capable of holding the open/closed state of the first flow channel in each of the open state and the closed state even if electricity is not continuously supplied. The movable piece may not have a vent hole.

A material constituting a valve body base is not particularly limited. The valve body base may be made of a non-magnetic material or may be made of resin. A small diameter part may not have a root and a joint. In this case, an annular elastic body has no sandwiched part. The annular elastic body may be constituted of any material as long as it has elasticity. A material constituting an annular elastic body may be an elastomer in addition to rubber. A method of attaching the annular elastic body to the valve body base is not particularly limited. The annular elastic body may be fixed to the valve body base by using an adhesive.

Each of the seal surface, the second contact surface, the step surface, and the annular protrusion may be provided in any manner and may have any size as long as at least portions thereof overlap each other when viewed in the predetermined direction (axial direction). For example, a portion of the step surface may not overlap the second contact surface and the seal surface when viewed in the predetermined direction. The entire seal surface and the entire annular protrusion may overlap each other when viewed in the predetermined direction. In this case, an inner edge of the seal surface overlaps an inner edge of the annular protrusion when viewed in the predetermined direction, and an outer edge of the seal surface overlaps an outer edge of the annular protrusion when viewed in the predetermined direction. The inner edge of the seal surface may be located on a side outward from the inner edge of the annular protrusion when viewed in the predetermined direction. The outer edge of the seal surface may be located on a side inward from the outer edge of the annular protrusion when viewed in the predetermined direction.

The purpose of the valve device to which the disclosure is applied is not particularly limited. For example, the valve device may be mounted in equipment in addition to a vehicle.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A valve device comprising:
a flow channel member that has a first flow channel; and
an electromagnetic valve that has a movable piece capable of moving in a predetermined direction and is capable of opening and closing the first flow channel,
wherein the first flow channel has an opening which opens to one side in the predetermined direction,
wherein the flow channel member has an annular protrusion which surrounds the opening,
wherein the movable piece has a valve body which is able to come into contact with the annular protrusion from the one side in the predetermined direction,
wherein the valve body has:
a valve body base which has a large diameter part and a small diameter part having an outer diameter smaller than an outer diameter of the large diameter part and connected to the large diameter part on the other side in the predetermined direction with a step therebetween; and
an annular elastic body which has an annular shape surrounding the small diameter part and is attached to the valve body base,
wherein the small diameter part has a flange which protrudes outward in a radial direction,
wherein the annular elastic body has:
a first contact surface which comes into contact with a surface of the flange on the one side in the predetermined direction;
a second contact surface in an annular shape which comes into contact with a step surface of the step directed to the other side in the predetermined direction; and
a seal surface in an annular shape which is able to come into contact with the annular protrusion from the one side in the predetermined direction, and
wherein at least portions of the seal surface, the second contact surface, the step surface, and the annular protrusion overlap each other when viewed in the predetermined direction.

2. The valve device according to claim 1, wherein an inner edge of the seal surface is located on a side inward from an inner edge of the annular protrusion when viewed in the predetermined direction, and
wherein an outer edge of the seal surface is located on a side outward from an outer edge of the annular protrusion when viewed in the predetermined direction.

3. The valve device according to claim 1, wherein the entire seal surface overlaps the second contact surface and the step surface when viewed in the predetermined direction.

4. The valve device according to claim 1,
wherein the small diameter part has:
a root which is connected to the large diameter part; and
a joint which has an outer diameter smaller than an outer diameter of the root and an outer diameter of the flange and which connects the root and the flange to each other in the predetermined direction,
wherein the annular elastic body has a sandwiched part in an annular shape which surrounds the joint and is sandwiched between the root and the flange in the predetermined direction, and
wherein the sandwiched part has:
the first contact surface; and
a third contact surface which comes into contact with a surface of the root on the other side in the predetermined direction.

5. The valve device according to claim 1, wherein the electromagnetic valve has a guiding tube in a tubular shape which surrounds the movable piece,
wherein the guiding tube supports the movable piece in a manner of being able to move in the predetermined direction,
wherein the flow channel member has:
a valve chamber into which the valve body is inserted; and
a second flow channel which is connected to the valve chamber,
wherein the first flow channel is a flow channel which is connected to the valve chamber via the opening and through which a fluid flowing into the valve chamber passes,
wherein the second flow channel is a flow channel through which a fluid that has flowed into the valve chamber via the first flow channel flows out,
wherein the movable piece has a vent hole which is connected to an inside of the electromagnetic valve,
wherein the vent hole has an outer opening which opens to an inside of the valve chamber in a state in which the seal surface comes into contact with the annular protrusion, and
wherein the entire outer opening is accommodated inside the guiding tube in a state in which the seal surface is farthest from the annular protrusion in the predetermined direction.

6. The valve device according to claim 5, wherein the electromagnetic valve has an elastic member which applies an elastic force to the movable piece in the predetermined direction,
wherein the elastic member is provided inside the electromagnetic valve, and
wherein the vent hole has an inner opening which opens to a portion inside the electromagnetic valve where the elastic member is provided.
